(19) United States
(12) Patent Application Publication
(10) Pub. No.: US 2011/0232816 A1
(43) Pub. Date: Sep. 29, 2011

(54) TIRE TREAD

(76) Inventors: Daniel Scott Sheehan, Akron, OH (US); Maurice Jacob Frank, North Canton, OH (US); Gilles Faber, Bettendorf (LU)

(21) Appl. No.: 13/030,408

(22) Filed: Feb. 18, 2011

Related U.S. Application Data
(60) Provisional application No. 61/317,605, filed on Mar. 25, 2010.

(51) Int. Cl. B60C 11/13

(52) U.S. Cl. 152/209.24

(57) ABSTRACT

A pneumatic tire is disclosed having circumferential grooves having an asymmetrical cross-sectional shape. The circumferential grooves may also be located asymmetrically on the outer tread surface.

### CROSS REFERENCE TO OTHER APPLICATIONS

This application claims the benefit of and incorporates by reference U.S. Provisional Application No. 61/317,605 filed Mar. 25, 2010.

### FIELD OF THE INVENTION

The present invention is directed to a pneumatic tire. More specifically, the invention is directed to a tire tread pattern having grooves of a particular configuration.

### BACKGROUND OF THE INVENTION

Tires used in industrial settings such as port applications or other industrial applications may often have circumferential grooves. Cracks may develop in the base of the groove due to the heavy loading of the vehicles. It is thus desired to have an improved tread configuration which solves the problem of the groove base cracking.

### Definitions

The following definitions are controlling for the disclosed invention.

“Axial” and “axially” are used herein to refer to lines or directions that are parallel to the axis of rotation of the tire.

“Circumferential” means lines or directions extending along the perimeter of the surface of the annular tire parallel to the Equatorial Plane (EP) and perpendicular to the axial direction.

“Equatorial plane (EP)” means the plane perpendicular to the tire's axis of rotation and passing through the center of its tread.

“Groove” means an elongated void area in a tread that may extend circumferentially or laterally about the tread in a straight curved, or zigzag manner. Circumferentially and laterally extending grooves sometimes have common portions and may be sub classified as “wide,” “narrow,” or “slot.” A “slot” is a groove having a width in the range from about 0.2% to 0.8% of the compensated tread width, whereas a “narrow groove” has a width in the range from about 0.8% to 3% of the compensated tread width and a “wide groove” has a width greater than 3% thereof. The “groove width” is equal to tread surface area occupied by a groove or groove portion, the width of which is in question, divided by the length of such groove or groove portion; thus, the groove width is its average width over its length.

“Lateral” means an axial direction.

### BRIEF DESCRIPTION OF THE DRAWINGS

The invention will be described by way of example and with reference to the accompanying drawings in which:

FIG. 1 is a perspective view of a tire tread of the present invention;

FIG. 2 is a front view of a tire tread of FIG. 1;

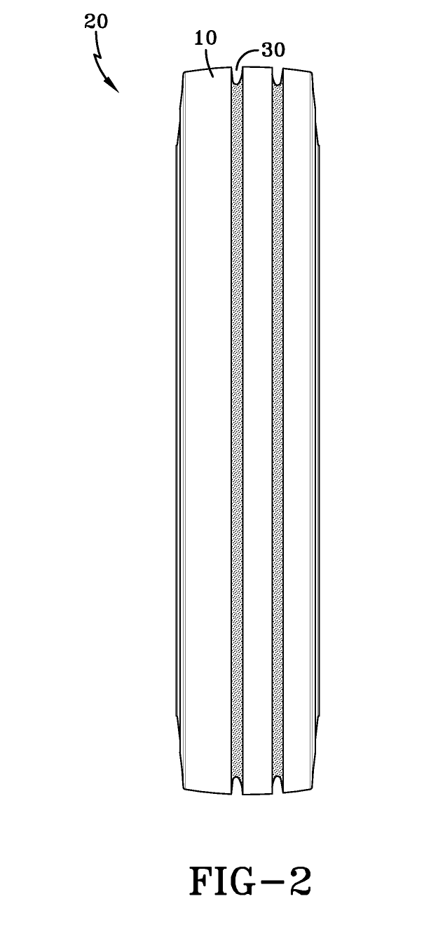

FIG. 3 is a cross-sectional view of the tire of FIG. 1;

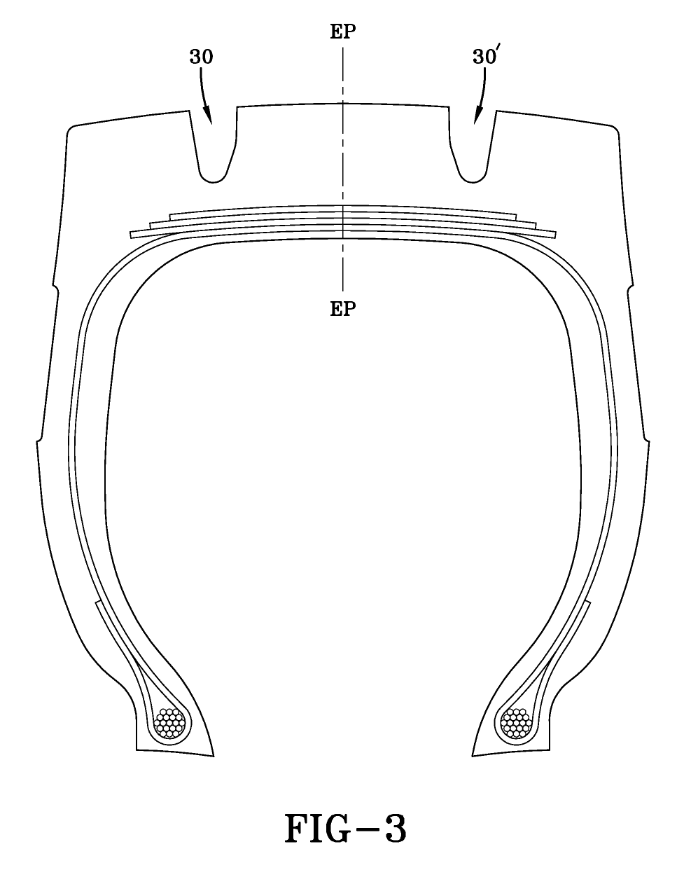

FIG. 4 is a closeup cross-sectional view of a groove of FIG. 3; and

FIG. 5 is a cross sectional view of a second embodiment of a tire of the present invention.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification. For purposes of this application, the various embodiments illustrated in the figures may use the same reference numeral for similar components. The structures employed basically the same components with variations in location or quantity thereby giving rise to the alternative constructions in which the inventive concept can be practiced.

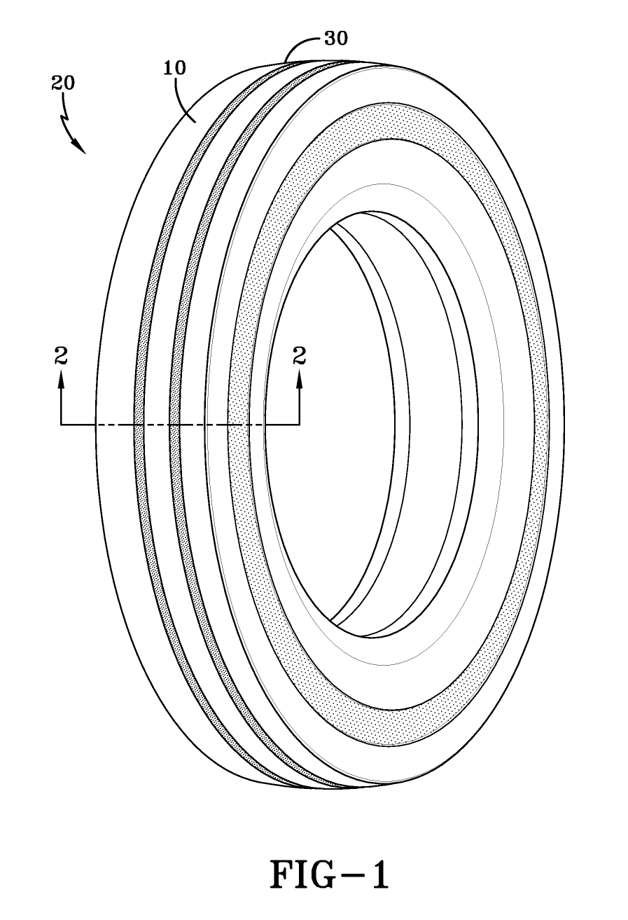

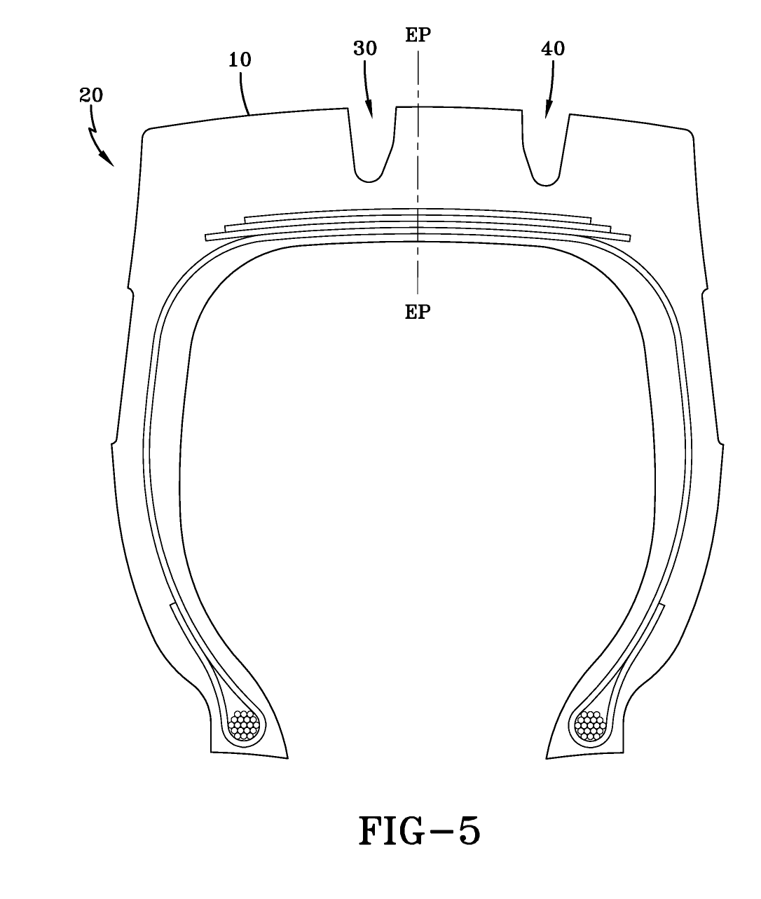

FIG. 1 is a tire tread 10 for a pneumatic tire 20 of the present invention. The tread configuration has at least one circumferential groove 30, and preferably has at least two circumferential grooves. The circumferential groove 30 is preferably continuous along the outer surface of the tread. The tread configuration preferably has no lateral grooves. The circumferential groove may be located on the centerline of the tire, or in close proximity to the centerline of the tire. The circumferential groove is preferably located in an asymmetric location on the outer tread surface (i.e., not centered on the midcircumferential plane). FIG. 5 illustrates one example of an asymmetric location for circumferential groove 30. In other words, the groove is not placed on the centerline of the tire. If two grooves 30, 40 are used, one groove 30 is preferably located closer to the midcircumferential plane than the other groove. More preferably, the groove orientation 40 is the mirror image of the groove 30.

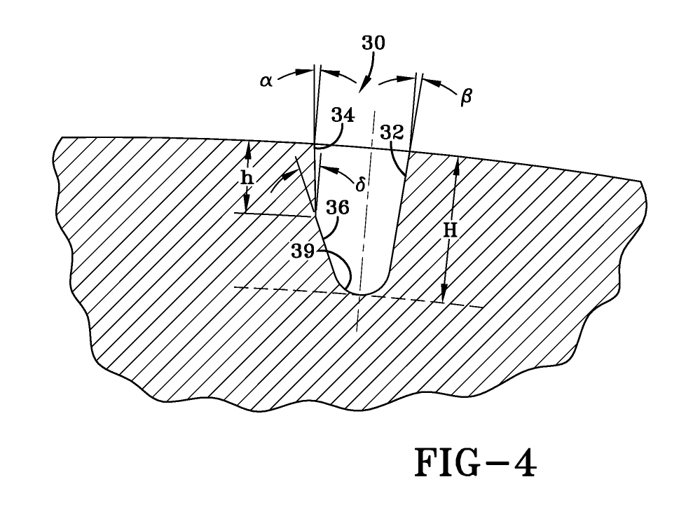

The cross-sectional shape of the groove 30 is shown in FIG. 4. The groove 30 has opposing groove walls 32, 34 which are non-parallel and are planar. The first groove wall 32 is inclined at an angle β of about 3 to about 8 degrees relative to a line perpendicular to a tangent to the tread surface, and more preferably in the range of about 4 to about 6 degrees, and most preferably about 4 to about 5 degrees. The second groove wall 34 is inclined at an angle α in the range of about 4 to about 7 degrees wherein the angle α is inclined relative to a line perpendicular to a tangent to the tread surface. Preferably α is greater than β. It is also preferred that α have a different angular value than β so that they are not equal. The second groove wall 34 extends into the tread a depth h, wherein h is about ⅓ to about ½ of the total groove depth H. The first groove wall 32 extends substantially the total depth of the groove H.

The groove wall 34 is joined with a middle portion 36 that has a large radius of curvature in the range of about 8 to about 15 inches, more preferably about 10 inches. Alternatively the middle portion 36 may also be planar and be inclined at an angle γ relative to a line perpendicular to a tangent to the tread surface in the range of about 18-22 degrees. The middle wall portion 36 is joined to the first groove wall via a large radiused groove bottom 39. The groove bottom is defined by a radius of curvature R of in the range of about 8 inches to about 15 inches, and more preferably about 10 inches.

What is claimed is:

1. A tire tread for a pneumatic tire, the tread comprising a first tread edge and a second tread edge, at least one groove, wherein the groove has a first and second opposing groove wall, the groove walls having inclination angles relative to a line perpendicular to a tangent to the tread surface,
the first groove wall having an inclination angle β in the range of 3°-8°;
a second groove wall having a radially outer portion having an inclination angle α in the range of 4°-7°, and a middle portion of the groove wall having an inclination angle γ in the range of 18° to 22°;
the intersection point between the radially outer portion and the middle portion of the groove wall being at a height of 40-60% of the groove depth, as measured from the groove bottom; and
a large radiused groove bottom joining the first groove wall to the middle portion of the second groove wall.

2. The tread of claim 1 wherein the groove is oriented in the circumferential direction.

3. The tread of claim 2 wherein the groove is circumferentially continuous.

4. The tread of claim 1 wherein the cross-sectional shape of the groove is asymmetrical.

5. The tread of claim 1 wherein the groove is not located on the tread centerline.

6. The tread of claim 1 comprising two grooves, wherein one groove is located closer to the tread centerline than the other groove.

7. The tread of claim 6 wherein one groove is the minor image of the other groove.
